(19) United States
(12) Patent Application Publication
(10) Pub. No.: US 2008/0168064 A1
(43) Pub. Date: Jul. 10, 2008

(54) Systems and Methods of Handling Overflow Storage

(75) Inventor: Joanne Dorsey, Lithonia, GA (US)

Correspondence Address: THOMAS, KAYDEN, HORSTEMEYER & RISLEY, LLP/;AT&T Delaware Intellectual Property, Inc., 600 GALLERIA PARKWAY, S.E., SUITE 1500, ATLANTA, GA, 30339-5994, US

(73) Assignee: BELLSOUTH INTELLECTUAL PROPERTY CORPORATION, Wilmington, DE (US)

(21) Appl. No.: 11/620,178

(22) Filed: Jan. 5, 2007

(51) Int. Cl. G06F 7/00; G06F 17/30

(52) U.S. Cl. 707/9; 707/E17.134

(57) ABSTRACT

Systems and methods are disclosed for processing incoming messages associated with a user. One exemplary method includes receiving an incoming message for a user account, determining whether at least one messaging impairment associated with the user account is present, storing the received message into a first storage location associated with the user account when no messaging impairment is present, and storing the received message into a second storage location associated with the user account when the at least one impairment is present.

### CROSS REFERENCE TO RELATED APPLICATIONS

Not applicable.

1. Field of the Disclosure

The present disclosure relates to electronic messaging systems, and more specifically, to handling overflow in an electronic messaging system.

2. Background

Electronic messaging systems, such as e-mail, voicemail, and text messaging, use a server to receive and store messages from senders to clients. Clients retrieve or access stored messages on the server. Each user account is typically limited in size (e.g., number of messages, total size of messages) and/or time. When the user account reaches this limit, conventional messaging systems refuse to accept incoming messages until the condition is resolved. While some messaging systems allow a user to increase the account limits, it may not be desirable, from either the user or messaging system provider point-of-view, to reserve additional space for the user account. This is especially true when reaching the limit is perceived to be an infrequent event. On the other hand, users who go on vacation without checking messages often return to find that e-mail or voicemail is full, and that the messaging system therefore refused to accept some new messages. Thus, a need arises for these and other problems to be addressed.

### SUMMARY

Embodiments of the present invention include a method for processing incoming messages associated with a user. The method includes receiving an incoming message for a user account, and determining whether at least one messaging impairment associated with the user account is present. The method further includes storing the received message into a first storage location associated with the user account when no messaging impairment is present, and storing the received message into a second storage location associated with the user account when the at least one impairment is present.

Embodiments of the present invention also include a system for processing storage of information associated with a user. The system includes a buffer for storing incoming information for a user account and means for determining whether at least one storage impairment associated with the user account is present. The system further includes means for storing the received information into a first storage location associated with the user account when no impairment is present; and means for storing the received information into a second storage location associated with the user account when the at least one impairment is present.

Embodiments of the present invention also include computer-readable medium. A program for processing storage of information associated with a user is stored on the medium. The computer-readable medium includes logic for receiving incoming information for a user account and logic for determining whether at least one storage impairment associated with the user account is present. The medium further includes logic for storing the received information into a first storage location associated with the user account when no impairment is present, and logic for storing the received message into a second storage location associated with the user account when the at least one impairment is present.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of an environment in which one embodiment of a system and method for handling overflow storage is located.

FIG. 2 is a block diagram of an environment in which another embodiment of a system and method for handling overflow storage is located

FIG. 3 is a block diagram showing various code and data items in the server of FIG. 2.

FIG. 4 is a flowchart showing processing of a received message by one embodiment of the overflow handler of FIG. 3.

FIGS. 5A and 5B are data flow diagrams of component interactions in the embodiment of FIG. 3.

FIG. 6 is a data flow diagram for another embodiment of the overflow handler of FIG. 3.

FIG. 7 is a flowchart of one embodiment of the access mechanism of FIG. 3.

FIG. 8 is a sequence diagram showing exemplary interactions between the client of FIG. 2 and the access mechanism of FIG. 3.

FIGS. 9A and 9B illustrate two embodiments of the overflow handling system of FIG. 2 which include an account manager component.

FIG. 10 is a hardware block diagram of a general-purpose computer which can be used to implement various embodiments of the client, server, and account manager of FIGS. 9A and 9B.

### DETAILED DESCRIPTION

The embodiments disclosed herein provide systems and methods for handling overflow in an electronic messaging system. A messaging server includes an overflow handler which operates when an impairment to receiving messages is present. Examples of impairments include, but are not limited to, reaching a limit on a default storage location for messages and receiving an undesirable user account status. One embodiment of the overflow handler stores overflow messages in an overflow storage location. Another embodiment of the overflow handler forwards messages to an alternate messaging handling system. The server may also include a unified access mechanism which allows clients to access messages in the default and overflow storage locations.

In some embodiments, the behavior of the overflow handler and/or client access to the overflow storage location is controlled by an account manager component. A user can interact with the account manager to subscribe to the overflow service. In one embodiment, overflow handling is not performed until the user subscribes. In another embodiment, overflow handling is performed by default, but access to the overflow storage location is not allowed until the user subscribes.

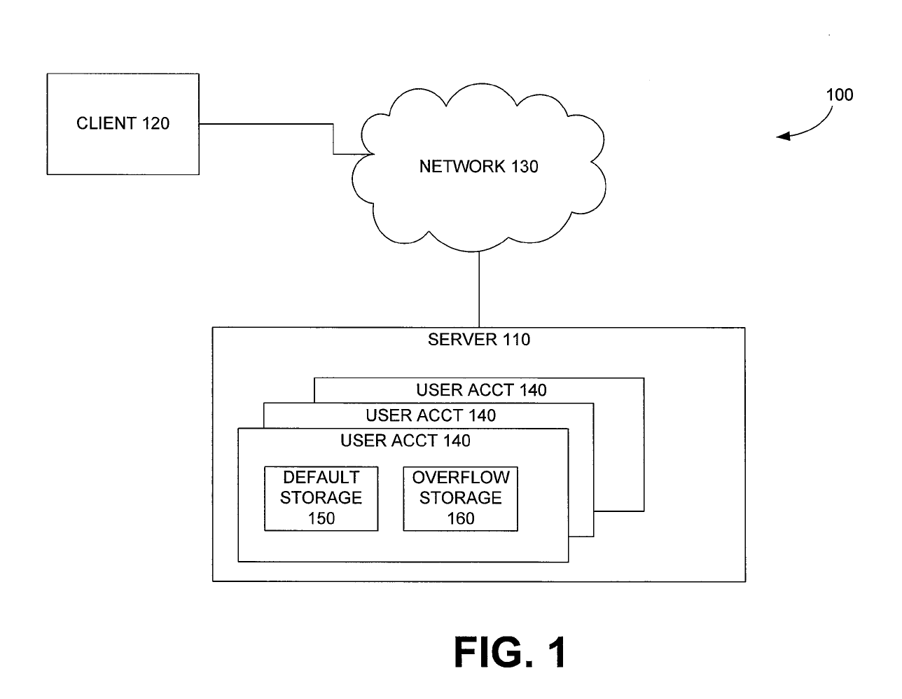

FIG. 1 is a block diagram of an environment in which one embodiment of a system and method for handling overflow storage is located. According to exemplary embodiments, system 100 includes a storage server 110 and at least one client device 120, which communicate over a network 130. The storage server 110 manages user account data 140 associated with the client device 120, which may include one or more storage areas that are accessible to the client device 120: a default storage area 150 and an overflow storage area 160. In some embodiments, the default storage 150 and the overflow storage 160 reside at the same location. In other embodiments, the default storage 150 and the overflow storage 160 reside at different locations. Storage servers and storage devices, for example systems incorporating hard disks, CD-ROM, and/or DVDs, should be known to one of ordinary skill in the art. Examples of storage servers and storage devices are those described in U.S. Pat. No. 6,839,803 to Loh et al. and U.S. Pat. No. 5,999,595 to Shaffer et al., which are hereby incorporated by reference.

In normal operation, requests by the client device 120 to store data on the storage server 110 are fulfilled by storing the data in the default storage 150. However, user account data may include one or more limits for the default storage 150, and reaching one or a combination of these limits is considered an impairment to storing new data in the user account 140. Examples of these limits include, but are not limited to, a total size in use, a total number of files in use, and a total number of messages in use.

As will be explained in more detail later, when an overflow, or impairment, condition exists, the storage server 110 determines whether new requests for storage are fulfilled, or are rejected. This determination may be based on preconfigured settings established by a system administrator, or on settings established by the user. Overflow settings established by the user may include information regarding payment for storage of new data when an impairment exists, access to the overflow storage 160, or both.

In some embodiments, when an overflow condition occurs, instead of storing the requested data, a pointer or reference to the requested information is maintained. For example, suppose a user with a client digital video recorder requests the storage server 110 to record a particular program. In such an embodiment, in a condition where the user's account is in overflow storage, the server 110 tracks the request, records the program, and moves the program to the user's account at a future time when the user's account does have storage available. In such a case, the storage appears to the user as virtual storage. In one embodiment, the service providing the storage server 110 charges the user for the “virtual” storage.

Content or data stored on the storage server 110, and accessed by the client device 120 may include, but is not limited to, voice, fax, data, web page, image, video, multimedia, audio, e-commerce transactions, and log or diagnostic files for a car, web server, computer or some other type of system. The network 130 may include any technology which allows the device 120 to communicate with the storage server 110. For example, the network 130 may include, but is not limited to, the Internet, a wide area network (WAN), a local area network (LAN), a wireless LAN (e.g., WiFi or WiMAX), a cellular network, a broadband network, a fiber-optic network, a television network (e.g., cable, satellite, over-the-air), a data broadcast (FLO), an Internet protocol television (IPTV) network, or a wireless local loop.

The client device 120 may include any device that utilizes storage. For example, the client device 120 may include, but is not limited to a phone, a personal data assistant (PDA), a personal computer (PC), a multimedia device, a digital camera, a digital video recorder, a music recorder, a cable set-top box, a satellite set-top box, a television, an entertainment device, a communication device, a telematics device, a home appliance, a wearable device, a monitoring device, an embedded device, an information device, a private branch exchange (PBX), and a gateway.

Applications executing on the client device 120 may include, but are not limited to, voicemail, video mail, entertainment, broadcast video, IPTV, e-commerce, instant messaging, e-mail, location services, search, voice over Internet Protocol (VoIP), a web browser, a Microsoft .NET® application, an enterprise application, a database application, an e-commerce application, a digital photograph application, a document management application, a monitoring application, and a synchronization application.

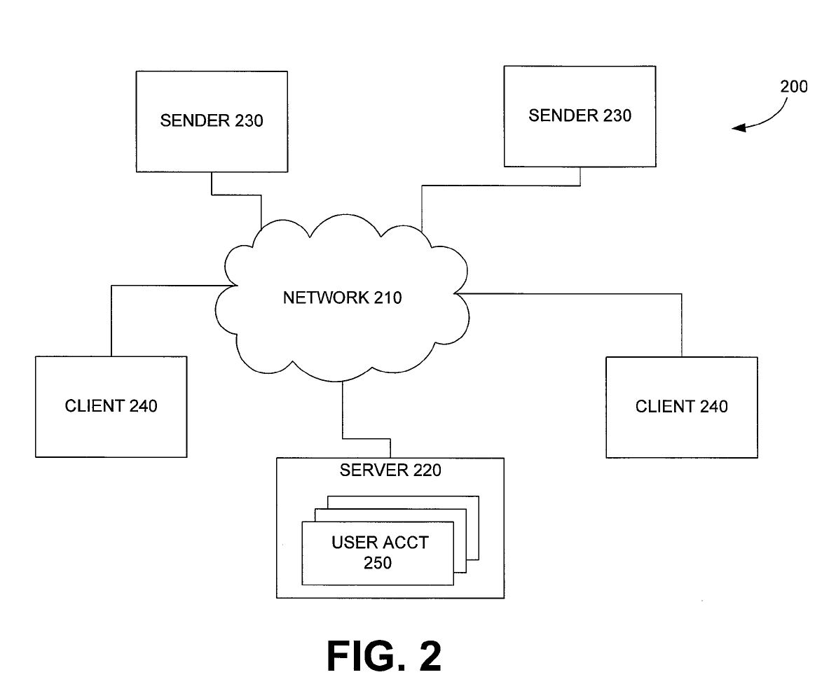

FIG. 2 is a block diagram of an environment in which one embodiment of a system and method for handling overflow storage is located. In this embodiment, the storage server is a messaging server, and the client device is a messaging client. According to exemplary embodiments, a messaging system 200 includes the senders 230, the server 220, and the clients 240, which communicate over a network 210. The messaging server 220 receives and stores messages sent by one or more senders 230 that are intended for messaging clients 240.

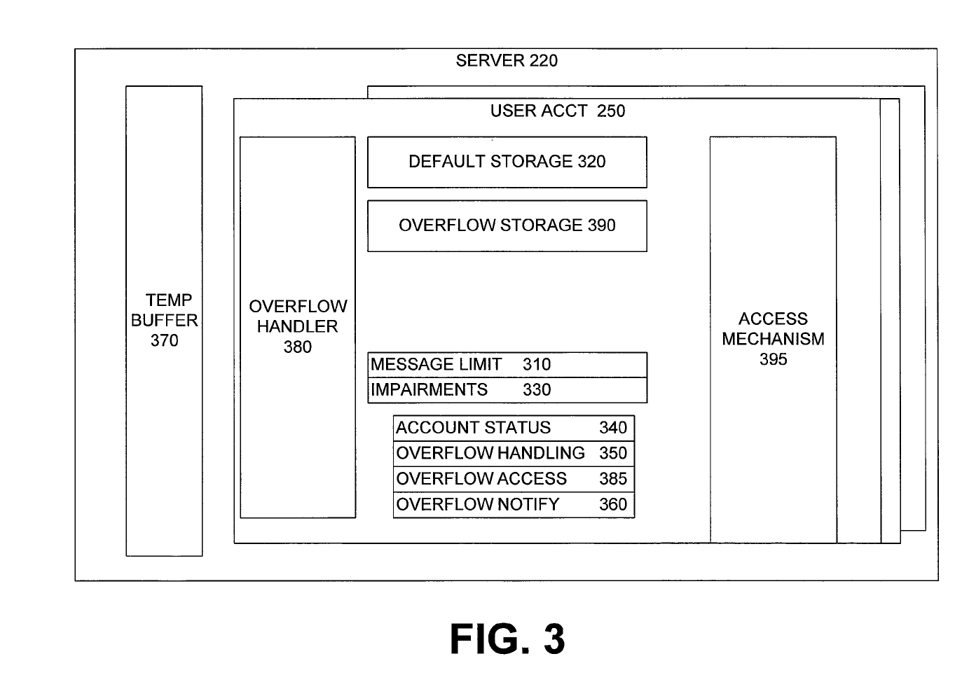

FIG. 3 is a block diagram showing various code and data items in the server 220. According to exemplary embodiments, the server 220 manages data (250) associated with a user (i.e., user account data), including storage, configuration settings and account settings. The user account data 250 may include one or more message limits 310 for a default storage 320. The user account data 250 may include a total size associated with the default storage 320 or a number of messages associated with the default storage 320. Reaching one of these limits 310, or a combination of these limits 310, is considered an impairment to receiving new messages associated with the account specified by user account data 250. The user account data 250 may also include, in some embodiments, ImpairmentData 330, which is a variable that tracks impairment conditions and related data.

Account information in the user account data 250 may include an account status 340 (e.g., “activated”, “deactivated,” “good standing,” “past due”). Some values of the account status 340 (e.g. “past due,” “deactivated”) can also be considered an impairment to receiving new messages for the user account data 250. Account information for the user account data 250 may also include an OverflowHandling setting or flag 350. Optional account information, present in some embodiments of the server 220, may also include an OverflowAccess setting 385, and an OverflowNotify setting 360.

Incoming messages may be temporarily stored in a message buffer 370. The overflow handler 380 uses the OverflowHandlingEnabled setting 350 to determine how newly received messages will be handled when an overflow, or impairment, condition exists. According to exemplary embodiments, the OverflowHandlingEnabled setting 350 indicates whether overflow processing is enabled. Under some conditions, messages that are received when an impairment condition exists are stored in an overflow storage area 390. In some embodiments, the default storage 320 and the overflow storage 390 reside at the same location. In other embodiments, the default storage 320 and the overflow storage 390 reside at different locations. The OverflowNotify setting 360 (if present) controls how server 220 will notify a user after handling a message overflow. The OverflowAccess setting 385 (if present) controls whether or not a user is allowed access to overflow messages. In one embodiment, described later, access to overflow messages is conditioned upon payment by the user to the messaging system provider.

The server 220 also includes code and/or data which provide user access to the storage areas managed by the server 220. Clients 240 may interact with an access mechanism 395 on the server 220 to retrieve messages. A person of ordinary skill in the art should understand that the details of the access mechanism 395 depend on the type of messaging system. In an e-mail messaging system, the access mechanism 395 may interact with the client 240 through an Internet protocol such as the Post Office Protocol (POP3) or Internet Messaging Protocol (IMAP). In a voicemail messaging system, the access mechanism 395 may implement an interactive voice response (IVR) system for message retrieval.

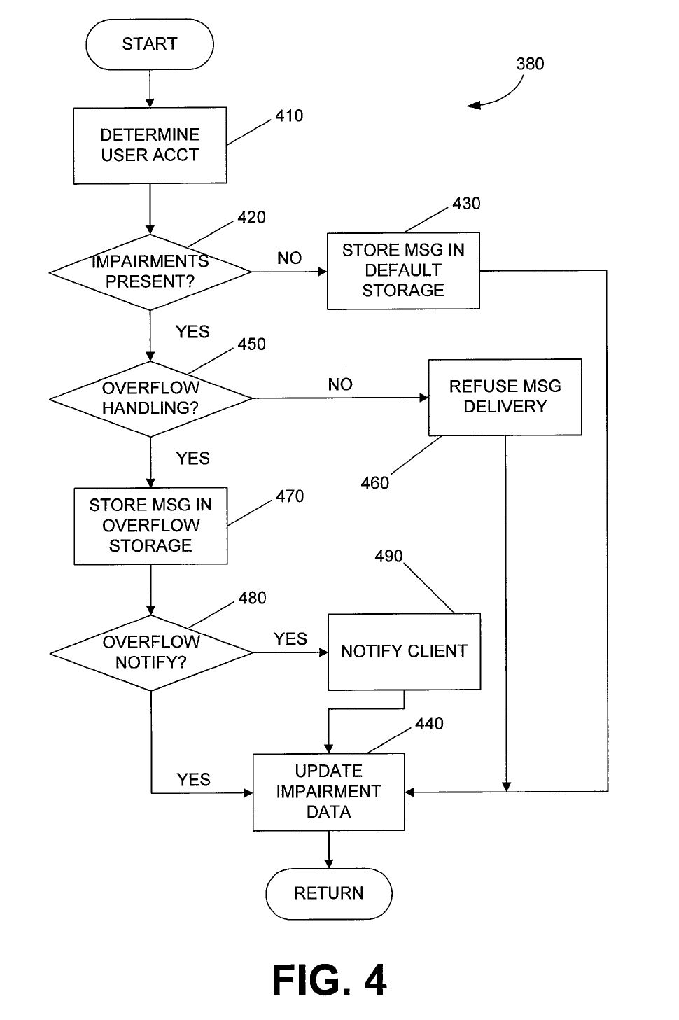

FIG. 4 is a flowchart showing processing of a received message by one embodiment of an overflow handler 380. At block 410, the intended recipient of the received message and the appropriate user account area 250 are determined. Next, at block 420, the overflow handler 380 checks for the presence of any impairments associated with the user account 250. The overflow handler 380 may determine if any impairments exist by comparing the number of messages and/or current size of data stored in the default storage 320 to the limits 310 associated with the user account data 250, and if the addition of the received message would not cause the default storage to exceed the limits, then the overflow handler determines that no impairments exist. If the addition of the received message would cause the default storage 320 to exceed the limits 310 associated with the user account data 250, then the overflow handler 380 determines that impairments exist.

If no impairments are present, the overflow handler 380 stores the message in the default storage 320 at block 430. Processing continues at block 440, which updates the ImpairmentData 330, if present in the particular embodiment. In one embodiment, the ImpairmentData 330 is a Boolean (True/False). In another embodiment, the ImpairmentData 330 also includes a count of messages received while the impairment was present. In yet another embodiment, the ImpairmentData 330 also includes elapsed time during which an impairment was present. The process returns after finishing block 440.

If any impairment is present, processing continues at block 450, where the OverflowHandlingEnabled setting 350 is checked by the overflow handler 380. If overflow processing is not enabled, then the incoming message is refused at block 460. In some embodiments, message refusal includes sending a “bounce-back” notification to the message sender. The process continues at block 440, where in some embodiments the ImpairmentData 330 is updated as described earlier, and the process returns.

If Overflow processing is enabled, then at block 470 the overflow handier 380 stores the message in the overflow storage 390. In some embodiments, a time limit may be associated with the overflow storage 390, so that a message saved to overflow storage is subject to being discarded when stored for a period longer than this time limit.

Block 480 is optional, depending on the particular embodiment of server 220. If present, the overflow handler 380 examines the OverflowNotify setting 360 at block 480 to determine if the user should be notified when a message is stored in the overflow storage 390. If Yes, then processing continues at block 490, where the user is notified. The process continues at block 440, where the ImpairmentData 330 (if present in a particular embodiment) is updated as described earlier, and the process returns.

A person of ordinary skill in the art should understand that the notification in block 490 may be accomplished in a variety of ways. As one example, the server 220 may place an ordinary message in the user's new messages area (e.g., a text e-mail with subject “Your mailbox has overflowed!”), or a message sent through a different type of messaging system (e.g., notify of e-mail overflow through a text message to a cell phone).

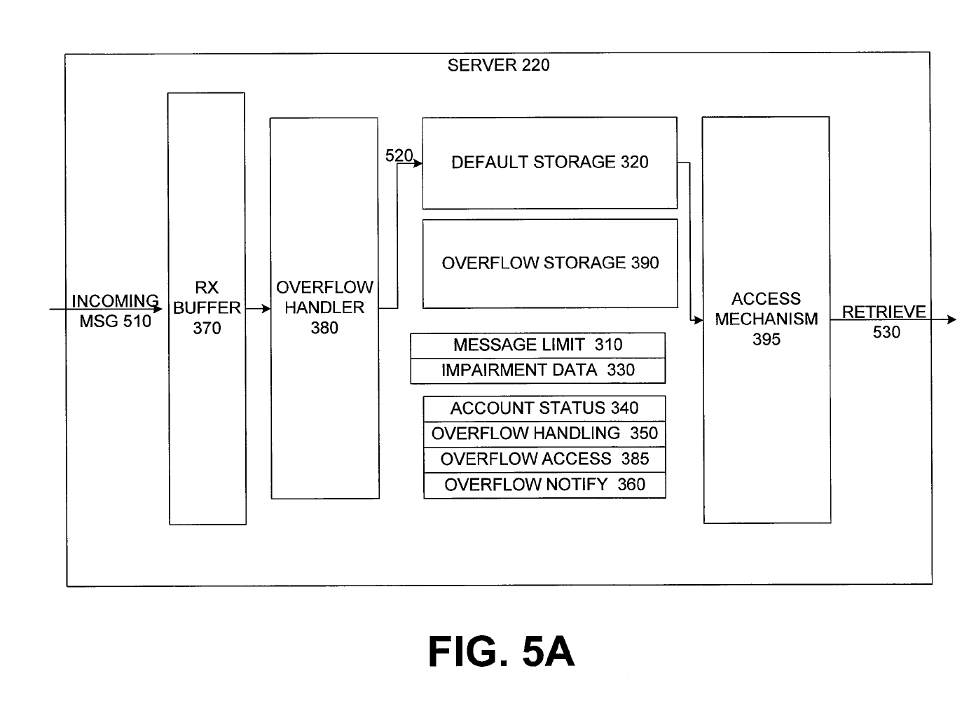

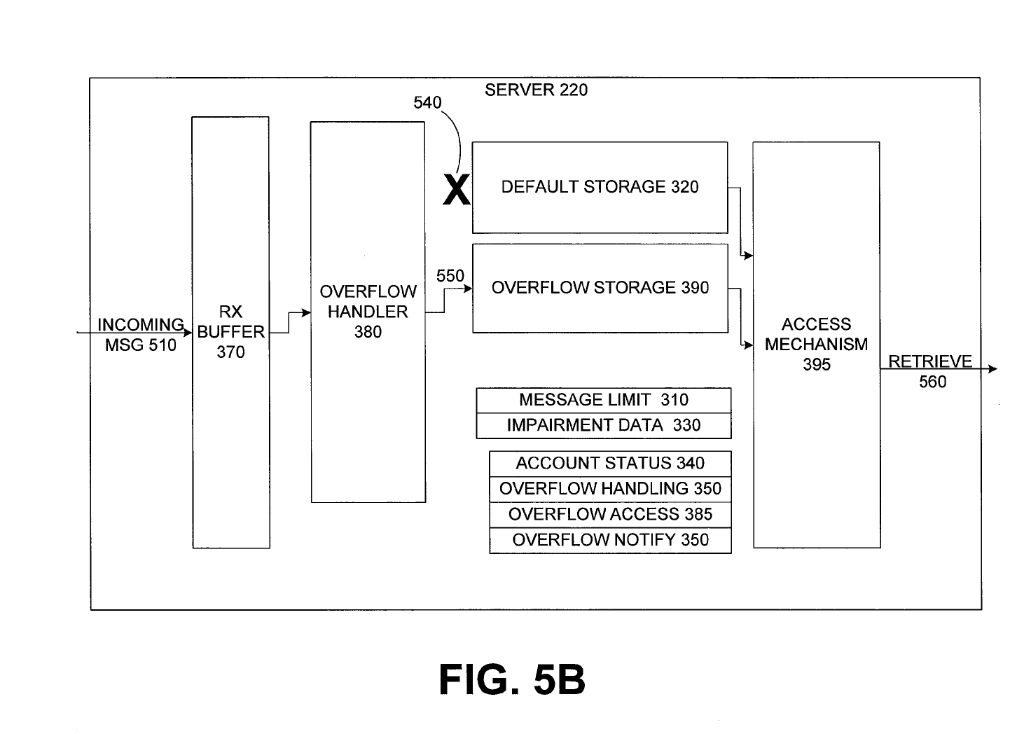

In the embodiment described in connection with FIG. 4, an overflow handler 380 stores messages in the overflow storage 390 when an impairment condition exists. FIGS. 5A and 5B are data flow diagrams illustrating processing of messages when an impairment condition does not exist and when an impairment condition does exist, respectively. FIG. 5A illustrates a messaging scenario in which overflow handling is enabled but no impairments are present. The server 220 receives (510) a message from the sender 230 and provides the message to buffer 370. The overflow handler 380 processes the message according to FIG. 4.

According to the embodiment illustrated in FIG. 5A, the overflow handler 380 has determined that the current size and/or total message count is under limits 310 and that the account status 340 is “good standing.” Thus, no impairments are present, and the overflow handler 380 provides (520) the message already in the temporary buffer 370 to the default storage 320. The access mechanism 395 draws on the messages in the default storage 320 when a user retrieves (530) or accesses messages through the unified access mechanism 395 and provides all or a portion of all the messages contained in the default storage.

FIG. 5B illustrates a messaging scenario in which overflow handling is enabled and an impairment is present. The server 220 receives (510) a message and provides it to into buffer 370, and overflow handler 380 processes the message according to FIG. 4. In this scenario, the current size and/or total message count is at or above limits 310. Thus, an impairment (540) is present, and the overflow handler 380 stores the message (550) in the overflow storage 390 rather than the default storage 320. The access mechanism 395 draws on the messages in the default storage 320 and in the overflow storage 390 when a user retrieves (560) or accesses messages through unified the access mechanism 395, and provides all or a portion of all of the messages from the default storage 320 and/or the overflow storage 390 to the user. In this manner, overflow handling is made transparent to the user, so that he is not required to retrieve messages from a separate “overflow” folder.

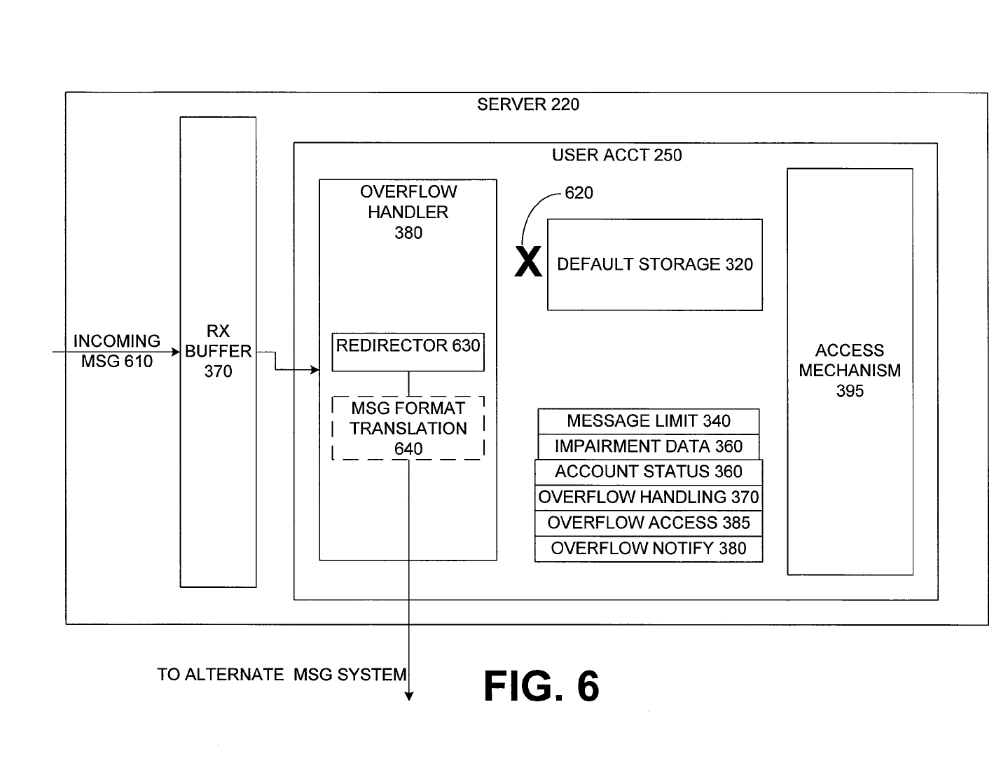

FIG. 6 is a data flow diagram including another embodiment of an overflow handler 380, in which messages are redirected, or forwarded, to another messaging system when an impairment condition exists. The server 220 receives (610) a message and provides the received message 610 to buffer 370. In this scenario, the overflow handler 380 has determined that an impairment (620) is present, and overflow handling is enabled. A redirector component (630) communicates with another messaging system (not shown) to forward, or redirect, the newly received message 610 to the other system. The redirector 630 may obtain information needed to communicate with the alternate messaging system (e.g., user's e-mail address on the alternate system) from user account data 250.

Some embodiments of the redirector 630 support alternate messaging systems which handle messages of a different type than the server 220. In one example, the server 220 is an e-mail system and the alternate system is a voicemail messaging system. In such embodiments, the redirector 630 may utilize a message format translation component (640) which translates between the messaging format used by the server 220 and the messaging format used by the alternate messaging system. One example embodiment of the translator 640 performs text-to-speech processing to translate a text e-mail message received by the server 220 to a speech audio file. The redirector 630 makes a phone connection to the user's voice mailbox on the alternate voicemail system and plays this audio file. In this manner, the original text e-mail message intended for a user is transformed into a voicemail message stored on an account associated with the user on an alternate messaging system.

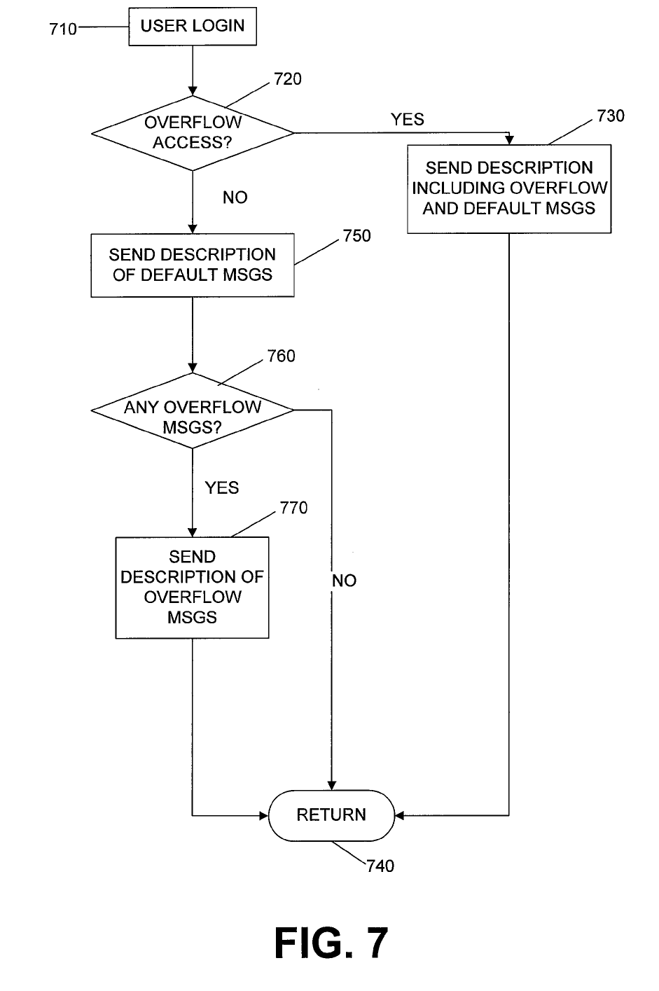

FIG. 7 is a flowchart of an embodiment of the access mechanism 395. In this embodiment, the decision whether to allow a user access to the messages in the overflow storage 390 is independent of the decision whether to store messages when an impairment exists. The flowchart of FIG. 7 illustrates only a portion of the access mechanism 395 which handles initial information exchange with the client 240 after a user of the account logs in to retrieve stored messages associated with the user account data 250.

The process begins after a successful user login at block 710. At block 720, the OverflowAccess setting 385 is examined by the access mechanism 395 to determine if the user is permitted access to messages in the overflow storage 390. If access is permitted, then processing continues at block 730, where a description of the messages in the default storage 320 and in the overflow storage 390 is sent to the client 240 by the access mechanism 395. Processing is then finished at block 740.

If no access is permitted, then processing continues at block 750, where a description of the messages in default storage 320 (but not the messages in the overflow storage 390) is sent to the client 240 by the access mechanism 395. In some embodiments, processing continues with (optional) block 760, where the access mechanism 395 determines whether the overflow storage 390 contains any messages. If Yes, then at block 770 a summary or partial description of messages in the overflow storage 390 is sent to the client 240, or a message indicating that the user has messages stored in the overflow storage 390 is provided to the client by the access mechanism 395. The access mechanism 395 may further provide the user with the option of purchasing an option to access the messages in the overflow storage 390.

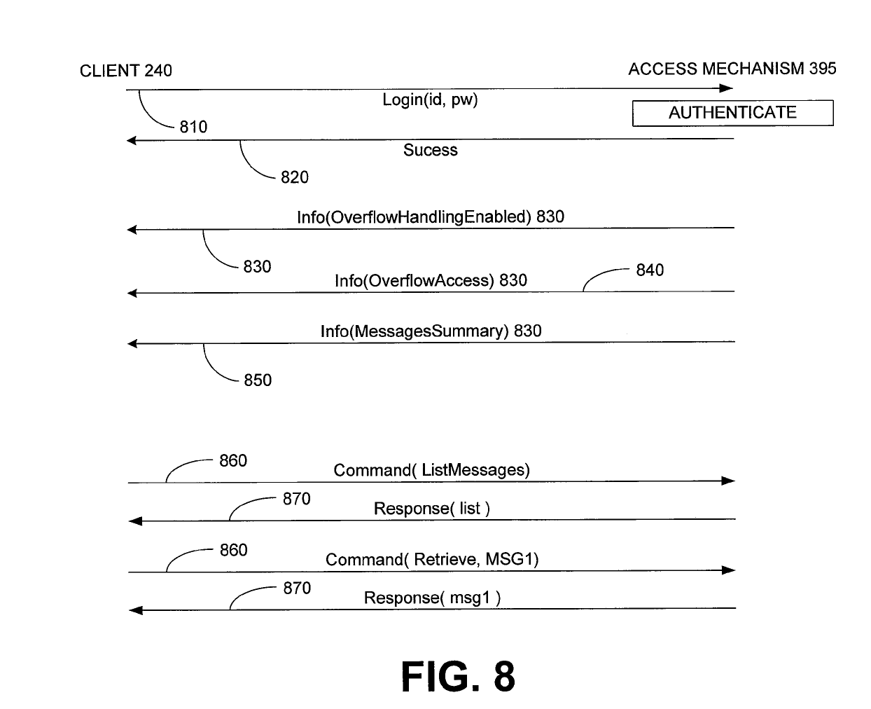

FIG. 8 is a sequence diagram showing exemplary interactions between the client 240 and the access mechanism 395. The scenario of FIG. 8 begins with the client 240 sending a login request (810) to the access mechanism 395. The access mechanism 395 authenticates the request, and returns a success/failure indication 820. The details of the login request and the authentication procedure may vary depending on the type of messaging system, as should be understood by a person of ordinary skill in the art. For example, an e-mail system may use a user identifier and a password for authentication, while a voicemail system may use a phone number and password, or password alone.

After the client is authenticated, the access mechanism 395 sends a series of indications to the client 240, conveying information about the configuration and status of the user account data 250 and the messages associated with the user account data 250. According to an exemplary embodiment, one indication (830) provides the client 240 with the OverflowHandlingEnabled setting 350. In response to this indication, the client 240 may provide this information to the user, in a manner appropriate to the messaging system. For example, an e-mail client might display an “Overflow Handling ON” string within the client window, and a voicemail client on a cell phone might display an icon representation. In a PBX voicemail system, the indication 830 might result in playback of a recorded message “Overflow handling is on.”

Another indication (840) provides the client 240 with the ImpairmentData 330. In response to this indication, the client 240 may provide this information to the user in a manner appropriate to the messaging system. For example, an e-mail client might display an “Overflow Triggered: inbox full” string within the client window. An e-mail client or a cell phone voicemail client might display a corresponding icon. In a PBX voicemail system, the indication 830 might result in playback of a recorded message “Message maximum reached: overflow has been triggered.”

Yet another indication (850) provides the client 240 with information about the number of stored messages. In one embodiment, the set of messages operated on depends on the OverflowAccess setting 385. As discussed earlier in connection with FIG. 7, if overflow access is allowed then messages from both the default storage 320 and the overflow storage 390 are considered. As explained before, according to exemplary embodiments, the access mechanism 395 presents a single unified view of both storage locations rather than distinguishing between the default storage 320 and the overflow storage 390. If overflow access is not allowed then messages from the default storage 320, but not from the overflow storage 390, are considered.

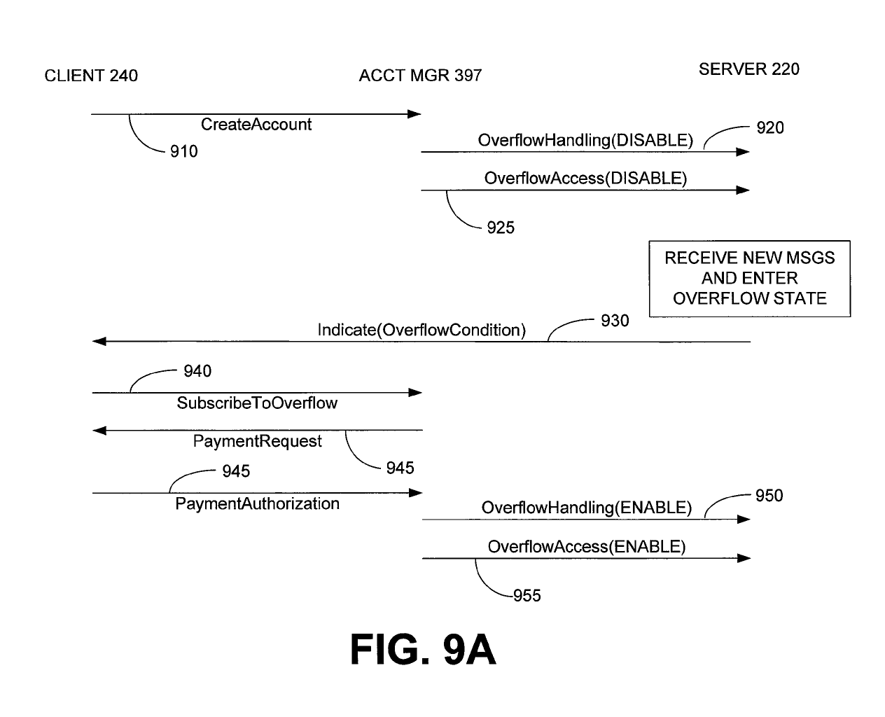

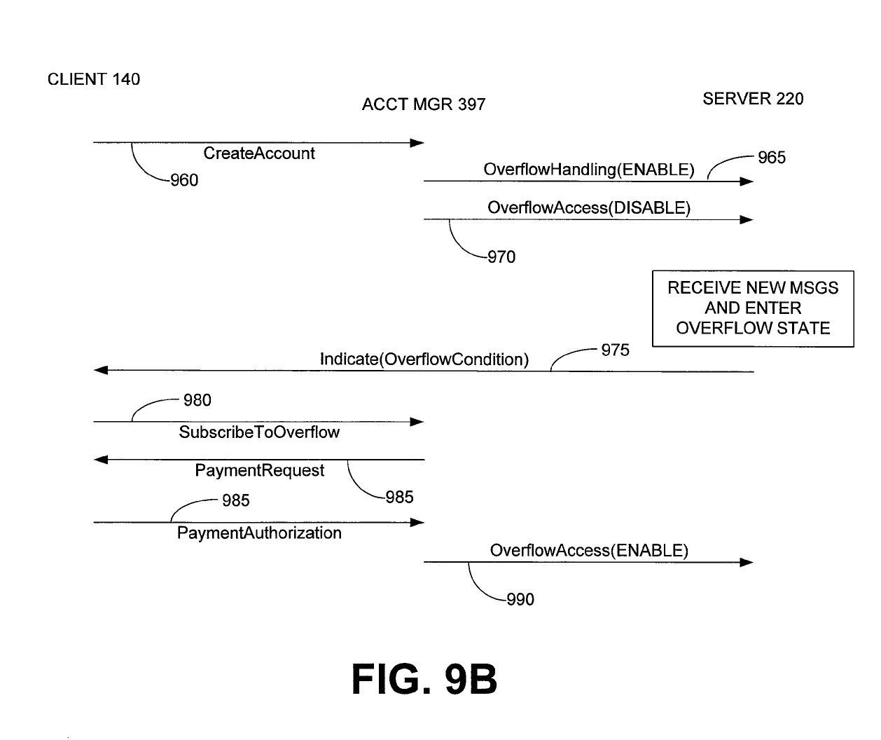

In other embodiments, the indication 850 operates on messages in the overflow storage 390, even when the OverflowAccess setting 385 is set to deny access. Thus, a user is informed through the indication 840 that an Overflow condition has occurred, and is also provided with summary information for messages in the overflow storage 390. In one of these embodiments, summary information in the indication 850 provides a preview of messages in the overflow storage 390, such as sender, message size, time of receipt, and/or subject line. After receiving such a preview, a user may be more likely to determine that overflow access is valuable to him, and thus be willing to pay to access the messages in the overflow storage 390. (Embodiments which allow a user to pay for overflow handling and for access to overflow messages will be discussed later in connection with FIG. 9.)

A person of ordinary skill in the art should understand that the indications 830-850 could occur in a different order, and that various embodiments of the access mechanism 395 are possible in which only a subset of these indications are used. Such a person should also understand that a request/response model could be used instead of unsolicited indications.

After this initial transfer of information, the client 240 sends one or more commands (860) to the access mechanism 395, and the access mechanism 395 may respond (870) to each. These commands allow the client 240 to perform operations on messages stored on the server 220. An exemplary list of the command includes, but is not limited to: provide a list of the messages; retrieve/view a message; and delete a message. The responses 870 provided by the access mechanism 395 are conditioned on the OverflowAccess setting 385: if access is allowed, the commands operate on messages in both the default storage 320 and the overflow storage 390; if access is not allowed, the commands operate only on messages in the default storage 320.

A person of ordinary skill in the art should understand that the interaction sequences of FIG. 8 are merely examples, and that details will depend on the messaging system 200. For example, in an e-mail system a server implementing the POP3 protocol will support one set of interactions while a server implementing the IMAP protocol will support another. The access mechanisms provided by various non-standardized voicemail systems will support yet another set of interactions. Therefore, other requests, replies, commands, and/or indications, and many combinations thereof, are also possible.

In some embodiments described herein, a system administrator of the system and method for handling overflow storage enables or disables the overflow service for particular user accounts. In other embodiments, the user manages overflow behaviors of the user account. FIGS. 9A and 9B illustrate two such embodiments of the messaging system 200 which include an account manager component (397). Account manager 397 interacts with the server 220 and the client 240 to manage the overflow behaviors of the user account.

FIG. 9A is a data flow diagram showing component interactions in one embodiment of the account manager 397. In this embodiment, the server 220 does not perform the overflow handling described unless the user subscribes to the overflow service. The scenario of FIG. 9A begins when a new user account is created (910). After the new account is created, the account manager 397 requests (920) the server 220 to disable overflow handling and to disable (925) overflow access. In another embodiment (not shown), the server 220 defaults to these settings, so that an explicit request or command by account manager 397 is not used.

At some later time, the client 240 is informed (indication 930) that an Overflow condition has occurred, and the user decides to subscribe to the overflow service. The client 240 interacts with account manager 397 to subscribe to the overflow service (940). In some embodiment, the subscription requires payment, so the client 240 and the account manager 397 interact to make payment arrangements (945). After payment, the account manager 397 enables (950) overflow handling on the server 220, and enables (955) overflow access on the server 220. According to exemplary embodiments, the account manager 397 enables overflow handling and access on the server 220 by setting the OverflowHandlingEnabled setting 350 and the OverflowAccess setting 385 associated with the user account to enabled.

In some embodiments, the subscription price depends on the account's settings for overflow handling. For example, a user may be charged a higher price for larger overflow storage 390, or a lower price for a higher limit on default storage 320 (i.e., less likely to trigger overflow handling). As another example, the subscription price may be related to the period of time for which overflow handling is enabled: a user may be charged more to keep overflow handling enabled for a week, than to keep overflow handling enabled for two days. Similarly, the subscription price may be related to the period of time for which access to overflow messages is enabled.

After the subscription, the client 240 retrieves and/or views already-received messages that are in the overflow storage 390, using the access mechanism 395 as described earlier. This retrieval is possible because overflow handling on the server 220 was enabled in response to the subscription transaction (at step 950).

FIG. 9B is a data flow diagram showing component interactions in another embodiment of the account manager 397. In this embodiment, the server 220 performs overflow handling, but user access is done through a subscription. The scenario of FIG. 9B begins when a new user account is created (960). After the new account is created, the account manager 397 requests (965) the server 220 to enable overflow handling, and to disable (970) overflow access. In another embodiment (not shown), the server 220 defaults to disabling overflow access, so that an explicit request or command by the account manager 397 is not used.

At some later time, the client 240 is informed (indication 975) that an Overflow condition has occurred. However, since overflow access is disabled, the user cannot yet access the messages in the overflow storage 390. In this scenario, the user decides to subscribe to the overflow service so that he can access the messages in the overflow storage 390. The client 240 interacts with the account manager 397 to subscribe to the overflow service (980). In some embodiment, the subscription requires payment, so the client 240 and the account manager 397 interact to make payment arrangements (985). As described earlier, the subscription price may depend on the account settings. After payment, the account manager 397 enables (990) overflow access on the server 220. After the subscription, overflow access begins and the client 240 can then retrieve and/or view newly received messages that go into the overflow storage 390 as well as previously received overflow messages (since overflow handling was enabled prior to overflow access being enabled), using the access mechanism 395 as described earlier.

In other embodiments, when the client 240 is informed (indication 975) that an Overflow condition has occurred, the client is also provided with a preview of messages in the overflow storage 390, such as sender, message size, time of receipt, and/or subject line. In these embodiments. After receiving such a preview, a user may decide to subscribe to the overflow service. Subscription, payment, and full access are then handled as described above.

In the embodiments described above, at least some portion of the overflow service is conditioned on a user subscription, which may require payment. Other embodiments allow a message sender, rather than the message recipient, to pay for the overflow storage. In one example of this type of embodiment, a caller who reaches a particular user's voicemail may hear a message “Jane's mailbox is currently full, but we can still deliver the message to Jane if you agree to pay a fee.” According to exemplary embodiments, after the caller makes payment arrangements, overflow handling for the particular user (in this case, Jane) is enabled. Moreover, overflow access may also be enabled for the particular user after the caller makes payment arrangements. In some embodiments, overflow handling is enabled only for the particular message for which the caller paid. Overflow access may also be enabled only for a particular message for which the caller paid.

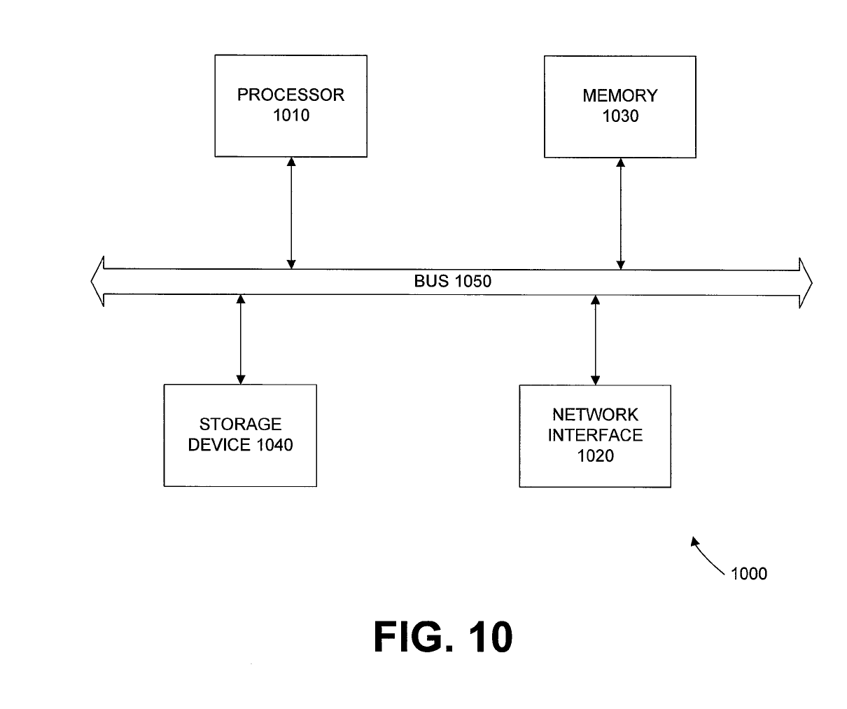

FIG. 10 is a hardware block diagram of a general-purpose computer 1000 which can be used to implement various embodiments of the client 240, the server 220, and/or the account manager 397. The computer 1000 contains a number of components that are well known in the art of contact center software, including a processor 1010, a network interface 1020, memory 1030, and storage device 1040. Examples of the storage device 1040 include, for example, a hard disk, flash RAM, flash ROM, and EEPROM. These components are coupled via a bus 1050. The memory 1030 contains instructions which, when executed by the processor 1010, implement systems and methods of handling overflow storage, such as the processes depicted in the diagrams of FIGS. 2-9. Omitted from FIG. 10 are a number of conventional components that are unnecessary to explain the operation of the computer 1000.

The systems and methods of handling overflow storage disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to): an optical fiber; and a portable compact disk read-only memory (CD-ROM). In addition, the functionality could be implemented in logic embodied in hardware or software-configured media.

Any process descriptions or blocks in flowcharts should be understood as representing modules, segments, or portions of code which include one or more executable instructions for implementing specific logical functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is at least:

1. A method for processing incoming messages associated with a user, the method comprising:
receiving an incoming message for a user account;
determining whether at least one messaging impairment associated with the user account is present;
storing the received message into a first storage location associated with the user account when no messaging impairment is present; and
storing the received message into a second storage location associated with the user account when the at least one impairment is present.

2. The method of claim 1, wherein the second storage location is not associated with the user account until the second storage location contains some data stored for the user.

3. The method of claim 1, wherein the impairment comprises the number of messages in the first storage location, or the total size of messages in the first storage location, reaching a limit associated with the first location.

4. The method of claim 1, wherein the impairment comprises a payment status of the user account being past due.

5. The method of claim 1, wherein storing the message into the second storage location is conditional on completion of a payment arrangement by the user.

6. The method of claim 1, further comprising:
allowing a user to retrieve messages in the second location,
wherein allowing a user to retrieve messages in the second location is conditional on completion of a payment arrangement by the user.

7. The method of claim 1, further comprising:
providing a unified mechanism for access to the messages in the first and in the second storage location.

8. The method of claim 1, further comprising:
permitting a user to access messages in the second storage location using a mechanism which is also used to access messages in the first storage location so that the storage location of a particular message is transparent to the user.

9. A system for processing storage of information associated with a user, comprising:
a buffer for storing incoming information for a user account;
means for determining whether at least one storage impairment associated with the user account is present;
means for storing the received information into a first storage location associated with the user account when no impairment is present; and
means for storing the received information into a second storage location associated with the user account when the at least one impairment is present.

10. The system of claim 9, wherein the incoming information is digital video, and further comprising:
means for communicating with a client digital video recorder (DVR) application.

11. The system of claim 9, wherein the incoming information is multimedia, and further comprising:
means for communicating with a client mobile multimedia application.

12. The system of claim 9, wherein the incoming information is a digital photograph, and further comprising:
means for communicating with a client digital photography application.

13. The system of claim 9, wherein the incoming information is an electronic document and further comprising:
means for communicating with a client document management application.

14. The system of claim 9, wherein the incoming information is an electronic commerce (e-commerce) transaction and further comprising:
means for communicating with a client e-commerce application.

15. The system of claim 9, wherein the incoming information is an electronic event and further comprising:
means for communicating with a client event monitoring application.

16. The system of claim 9, wherein the second storage location is not associated with the user account until the second storage location contains some data stored for the user.

17. The system of claim 9, further comprising:
a buffer for receiving a message associated with the user account;
means for determining whether at least one messaging impairment associated with the user account is present;
means for storing the received message into the first storage location associated with the user account when no messaging impairment is present; and
means for handling the received content when the at least one storage impairment is present.

18. The system of claim 9, further comprising:
means for receiving a user subscription request for an overflow service,
wherein the means for handling the received content is responsive to the means for receiving the user subscription request.

19. The system of claim 9, wherein the means for handling comprises:
means for forwarding the received content to an alternate storage system.

20. The system of claim 19, further comprising:
means for translating the received content from a first format supported by the system to a second format supported by the alternate storage system.

21. The system of claim 19, further comprising:
means for receiving a user subscription request for an overflow service,
wherein the means for storing has a default behavior of not storing the received content when at least one messaging impairment is present, and wherein the means for storing changes, responsive to the means for receiving the user subscription request, to a behavior of storing the received content.

22. A computer-readable medium having a program stored thereon, the program for processing storage of information associated with a user, comprising:
logic for receiving incoming information for a user account;
logic for determining whether at least one storage impairment associated with the user account is present;
logic for storing the received information into a first storage location associated with the user account when no impairment is present; and
logic for storing the received message into a second storage location associated with the user account when the at least one impairment is present.

23. The computer-readable medium of claim 22, wherein the second storage location is not associated with the user account until the second storage location contains some data stored for the user.

24. The computer-readable medium of claim 22, further comprising logic for storing the received message into the second storage location associated with the user account when overflow handling for the user account is enabled.
